(19) United States
(12) Patent Application Publication
(10) Pub. No.: US 2007/0244803 A1
(43) Pub. Date: Oct. 18, 2007

(54) Auction device and auction program

(75) Inventor: Yasuhiro Hirano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawaski (JP)

(21) Appl. No.: 11/802,748

(22) Filed: May 24, 2007

Related U.S. Application Data
(63) Continuation of application No. PCT/JP04/17695, filed on Nov. 29, 2004.

(51) Int. Cl. G06Q 40/00

(52) U.S. Cl. 705/37

(57) ABSTRACT

Disclosed is an auction device capable of selling a variety of commodities at an auction in such a form that the variety of commodities are not sold at excessively high prices. The auction device is configured to include a function of calculating a recommended suggested sales price used as an upper limit value of a bidding price of each of the variety of commodities and a function of prompting an exhibition requester to designate a designated suggested sales price used as the upper limit value of the bidding price of the commodity and outputting, if the designated suggested sales price designated by the exhibition requester is higher than the recommended suggested sales price that has been calculated, an instruction of changing the designated suggested sales price.

### TECHNICAL FIELD

The present invention relates to an auction device for marketing commodities at an auction and to an auction program for making a computer function as the auction device.

### BACKGROUND ARTS

As broadly known, in recent years, there have been conducted an auction (refer to Patent document 1) taking a mode of querying about whether or not a commodity can be sold at a price designated by a commodity exhibitor via the Internet and an auction of selling the commodity to a person who has bid the commodity at the highest price. The latter type of auction has, however, a high tendency that each of the commodities is to be sold at a higher price than a price at which the commodity originally should be sold.

[Patent document 1]

Japanese Patent Application Laid-Open Publication No. 2002-74075

### DISCLOSURE OF THE INVENTION

Such being the case, it is one object of the present invention to provide an auction device capable of selling a variety of commodities at an auction in such a form that the variety of commodities are not sold at excessively high prices.

Further, it is another object of the present invention to provide an auction program enabling a computer to function as the auction device capable of selling the variety of commodities at the auction in such a form that the variety of commodities are not sold at the excessively high prices.

To accomplish the objects, an auction device according to the present invention, which performs an auction via a network, is configured to comprise reference price storage means stored previously with a reference price corresponding to a type and a status of a commodity with respect to each of a multiplicity of commodities, acquiring means acquiring commodity information representing a type and a status of an exhibition request target commodity as an auction target commodity, and also a designated suggested sales price, and suggested sales price adjusting means calculating, with respect to the exhibition request target commodity, a recommended suggested sales price by use of the reference price stored in the reference price storage means and the commodity information, and outputting, if the calculated recommended suggested sales price is lower than the designated suggested sales price acquired by the acquiring means, an instruction of changing the designated suggested sales price.

Namely, the auction device according to the present invention, if the designated suggested sales price designated by the exhibition requester is improper (higher than the recommended suggested sales price), outputs an instruction of changing the designated suggested sales price. Accordingly, the use of the auction device according to the present invention enables realization of an environment where a variety of commodities are put on sale at the auction in a form that prevents the variety of commodities from being sold at excessively high prices.

On the occasion of realizing the auction device according to the present invention, the suggested sale price adjusting means can involve adopting means that prompts an operator to input a correction coefficient used for the exhibition request target commodity, and calculates the recommended suggested sales price by an arithmetic process using the inputted correction coefficient and a reference price of the commodity that is stored in the reference price storage means. Further, the auction device according to the present invention can further comprise sales target commodity registering means registering, if the designated suggested sales price is equal to or lower than the recommended suggested sales price, the exhibition request target commodity as an auction target commodity, commodity information presenting means outputting information on the exhibition request target commodity registered by the sales target commodity registering means in a biddable status, and bid accepting means accepting a bid of the outputted exhibition request target commodity if the inputted bidding price is equal to or lower than the recommended suggested sales price calculated about the exhibition request target commodity.

Then, an auction program according to the present invention enables a computer to function as a device equivalent to the auction device (as set forth in claim 1) according to the present invention. Accordingly, the use of the auction program according to the present invention also enables the realization of the environment where a variety of commodities are put on sale at the auction in a form that prevents the variety of commodities from being sold at the excessively high prices.

The use of the auction device and the auction program according to the present invention enables the realization of the environment where a variety of commodities are put on sale at the auction in a form that prevents the variety of commodities from being sold at the excessively high prices.

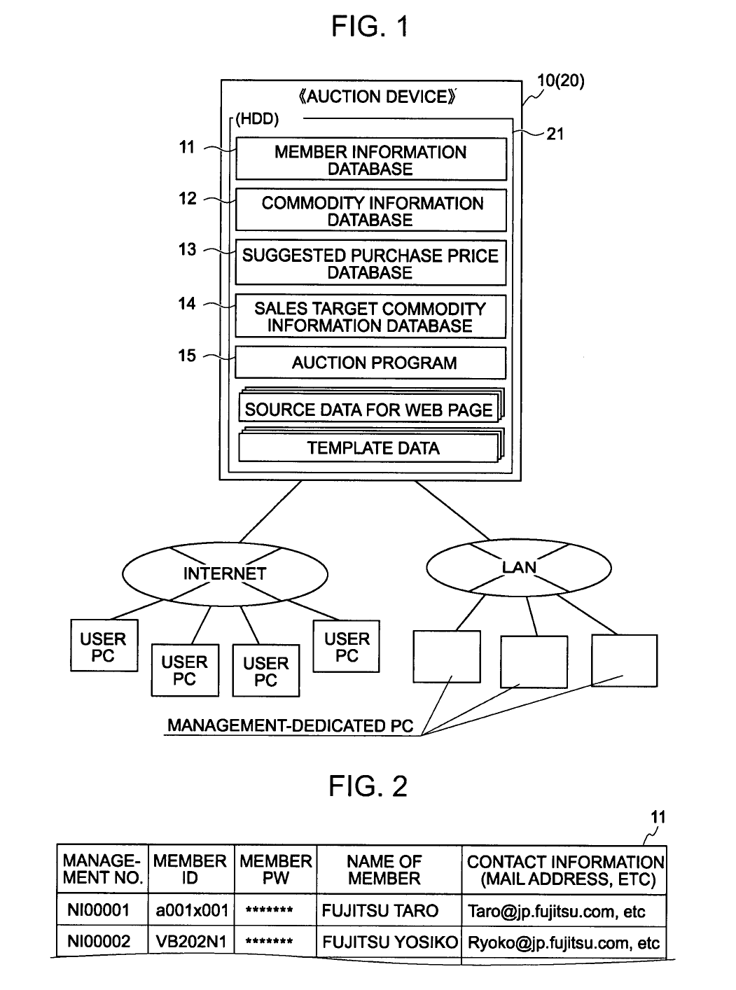

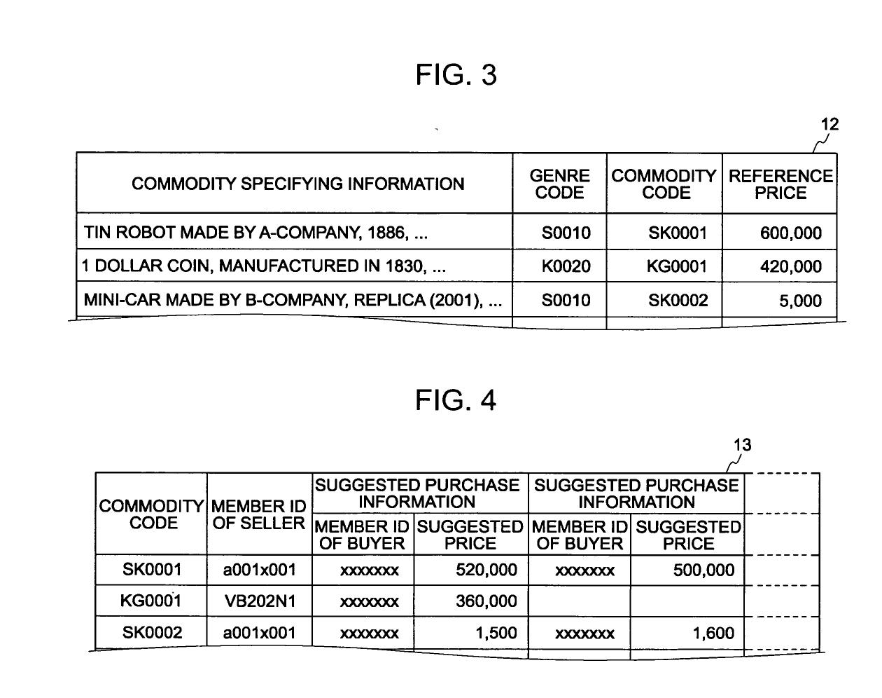

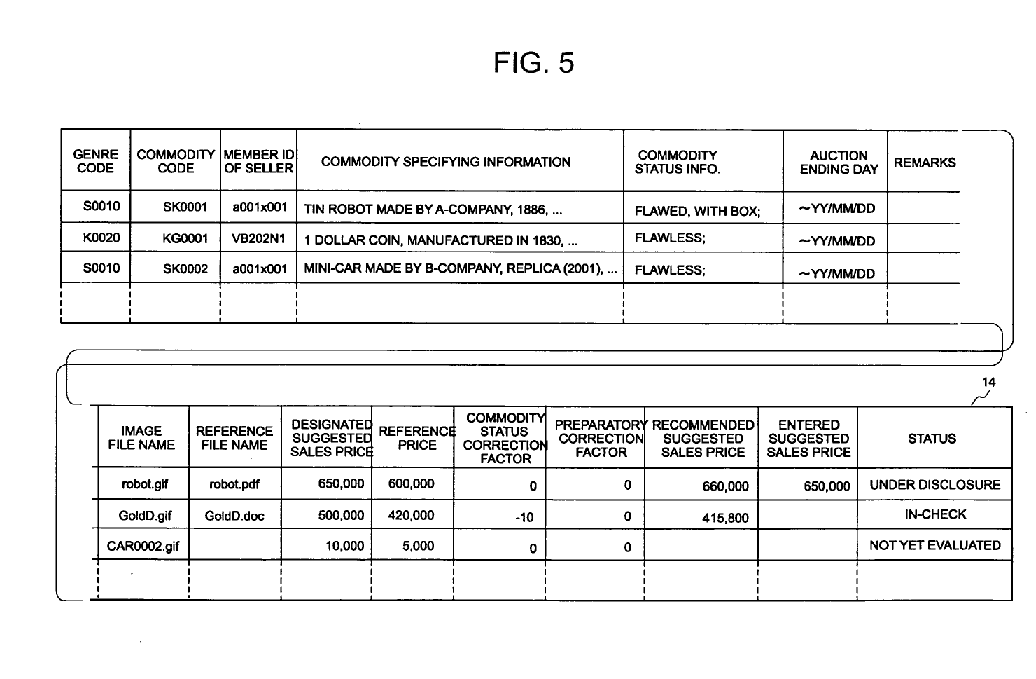

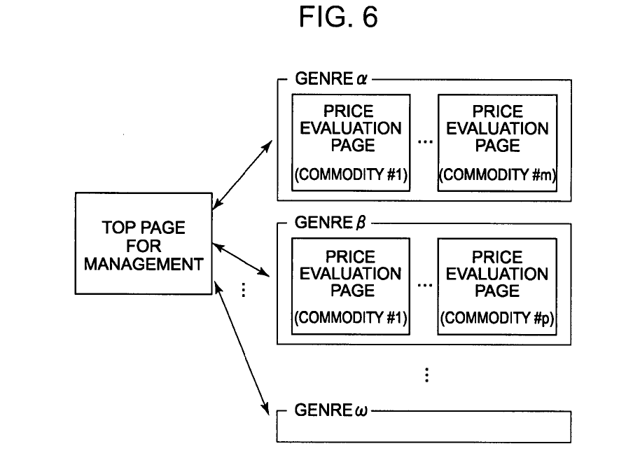

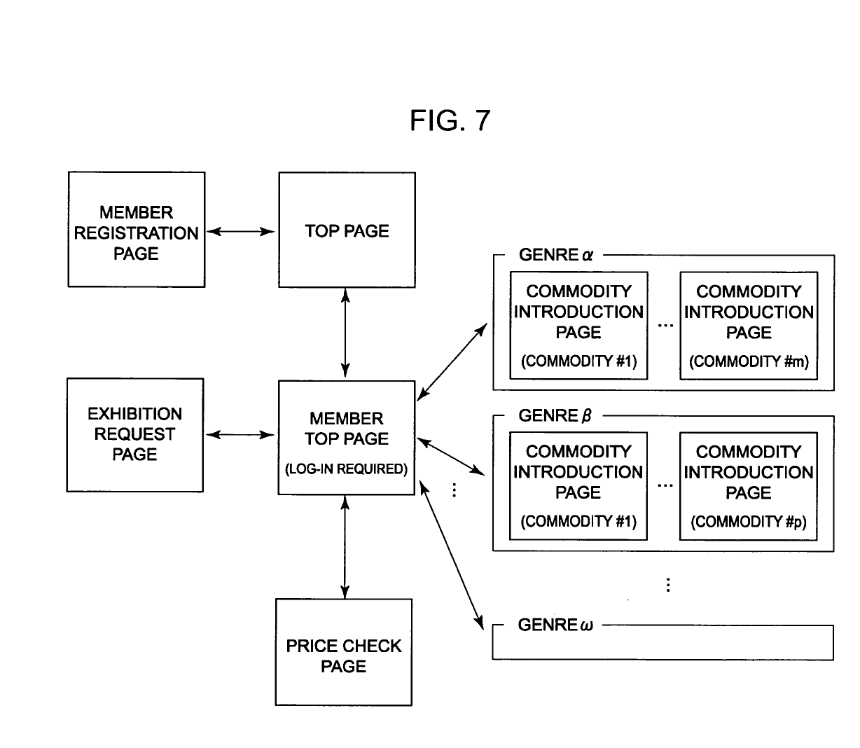

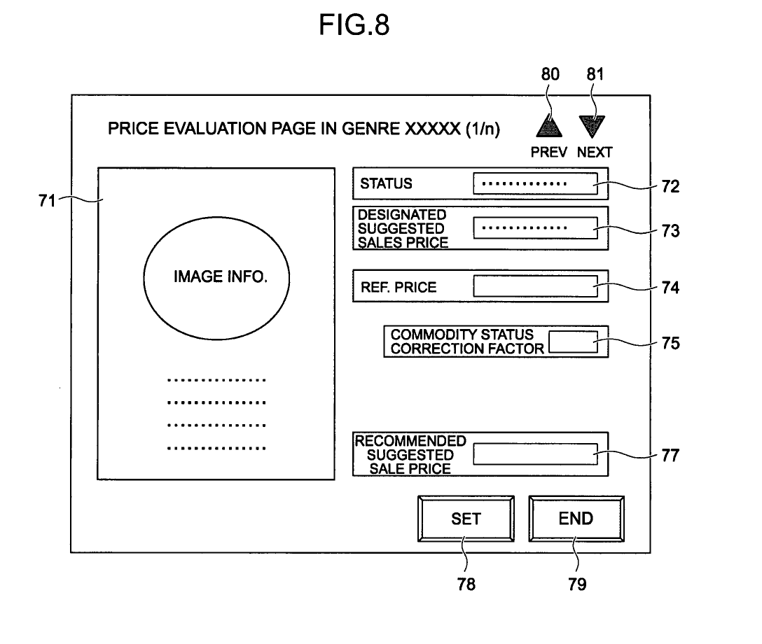

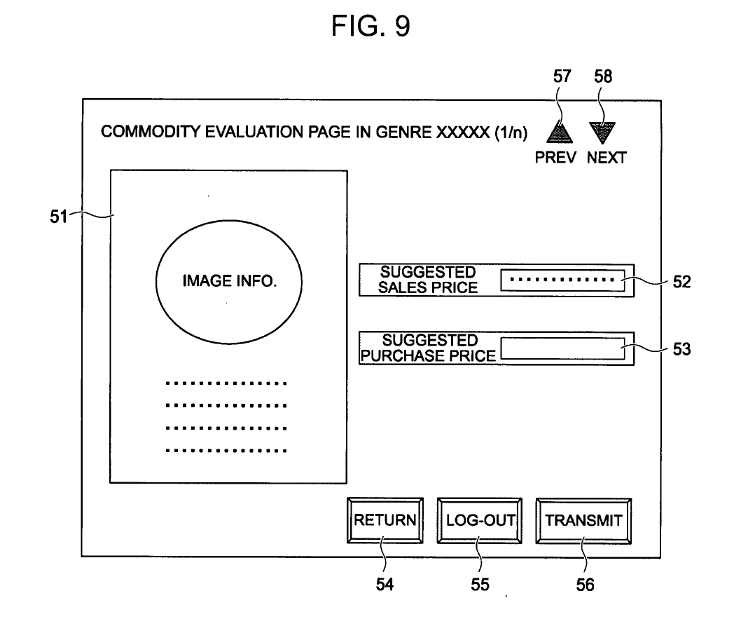

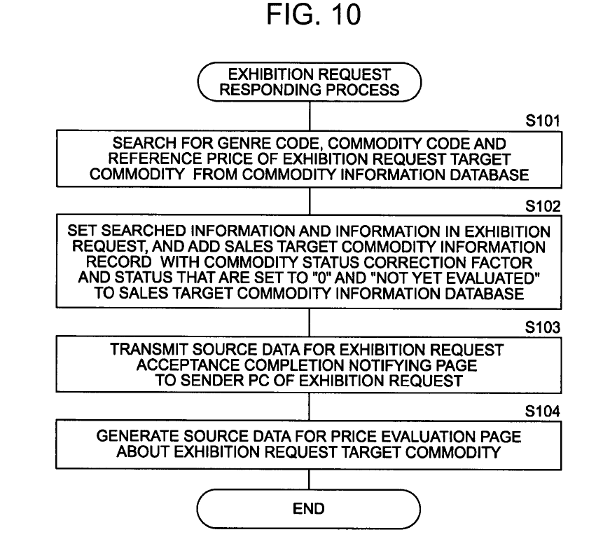

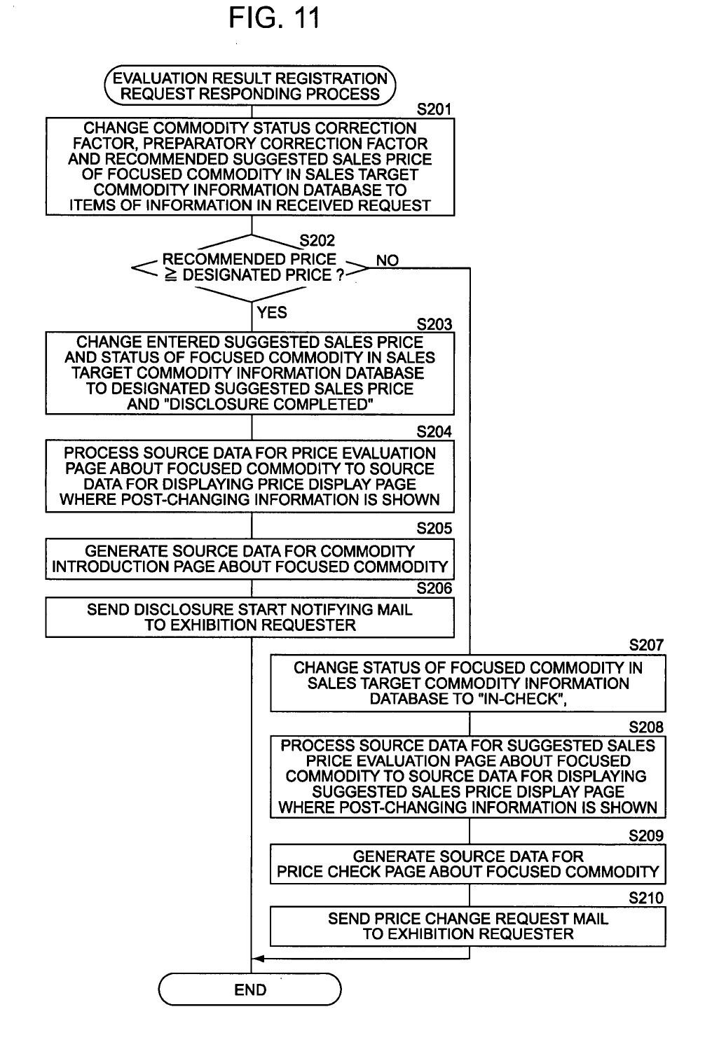

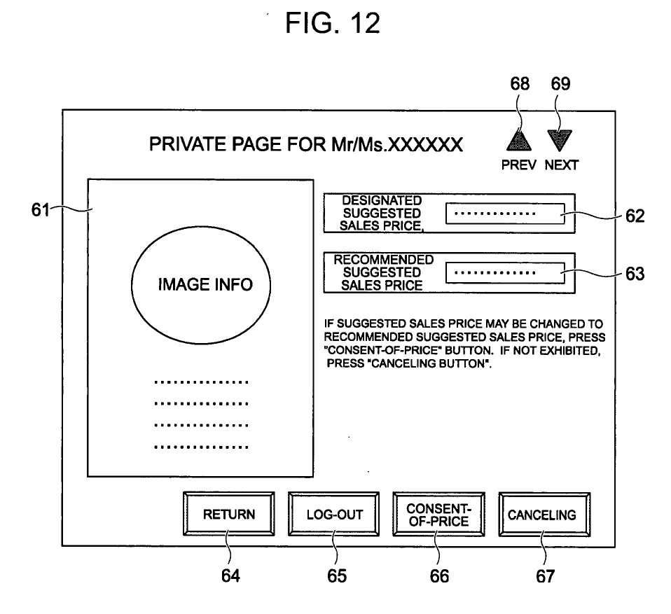

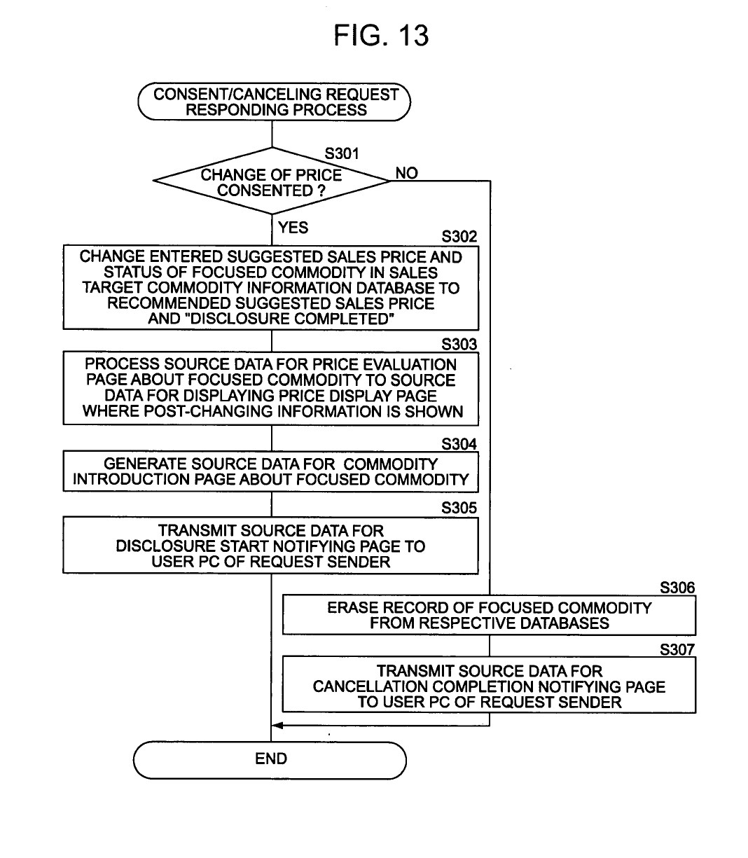

### BRIEF DESCRIPTION OF THE DRAWINGS

[FIG. 1] FIG. 1 is an explanatory diagram of a configuration and a using mode of an auction device according to one embodiment of the present invention.

[FIG. 2] FIG. 2 is an explanatory diagram of a member information database provided in the auction device.

[FIG. 3] FIG. 3 is an explanatory diagram of a commodity information database provided in the auction device.

[FIG. 4] FIG. 4 is an explanatory diagram of a suggested purchase price database provided in the auction device.

[FIG. 5] FIG. 5 is an explanatory diagram of a sales target commodity information database provided in the auction device.

[FIG. 6] FIG. 6 is an explanatory diagram of a Web page provided to a management-dedicated PC by the auction device.

[FIG. 7] FIG. 7 is an explanatory diagram of a Web page provided to a user PC by the auction device.

[FIG. 8] FIG. 8 is an explanatory diagram of a price evaluation page provided to the management-dedicated PC by the auction device.

[FIG. 9] FIG. 9 is an explanatory diagram of a commodity introduction page provided to the user PC by the auction device.

[FIG. 10] FIG. 10 is a flow chart of an exhibition request responding process executed by the auction device.

[FIG. 11] FIG. 11 is a flowchart of an evaluation result registration request responding process executed by the auction device.

[FIG. 12] FIG. 12 is an explanatory diagram of a price check page provided to the user PC by the auction device.

[FIG. 13] FIG. 13 is a flowchart of a consent/cancellation request responding process executed by the auction device.

### BEST MODE FOR CARRYING OUT THE INVENTION

A best mode for carrying out the present invention will hereinafter be described in depth with reference to the drawings.

To start with, an outline of an auction device 10 according to one embodiment of the present invention will be described with reference to FIG. 1.

As illustrated in FIG. 1, the auction device 10 according to the present embodiment is a device operated in a state of being connected via communication networks such as the Internet and a LAN (Local Area Network) to a plurality of personal computers (PCs) of users and to a plurality of management-dedicated PCs. Note that the user PC connotes a computer employed by a general type of user (a member or non-member) who markets the commodity at the auction and makes a bid. Further, the management-dedicated PC connotes a computer used by an operator (a person belonging to an administrator of the auction device 10).

Then, the auction device 10 is a device actualized (configured) by installing, into a HDD 21 of a computer 20 (having specifications enabling the computer itself as a server), a member information database 11, a commodity information database 12, a suggested purchase price database 13, a sales target commodity information database 14, an auction program 15, source data (HTML (HyperText Markup Language) data, image data, etc) of a variety of Web pages, various types of template data (enabling the HTML data to be generated by processing the items of template data themselves) and so on.

The auction device 10 is the device for handling the net auction. The auction device 10, if a suggested sales price designated by a commodity exhibition requester (client) is not proper as a suggested sales price of a display target commodity, prompts the commodity exhibition requester to reconsider the suggested sales price in a way that outputs an instruction of changing the suggested sales price. Further, the auction device 10, when determining that a bidding price is too high, does not accept the bid.

Based on what has been discussed so far as a premise, a configuration and an operation of the auction device 10 according to the present embodiment will be described more specifically.

The member information database 11, the commodity information database 12, the suggested purchase price database 13 and the sales target commodity information database 14, which are installed (stored) in the HDD 21, respectively have structures (of which the details will be explained later on) illustrated in FIGS. 2 through 5.

The auction program 15 stored in the HDD 21 runs to make the auction device 10 function as a device capable of executing a process of displaying a group of Web pages linked to each other as schematically illustrated in FIG. 6 on the management-dedicated PC (Web Browser), a process of displaying a group of Web pages linked to each other as schematically illustrated in FIG. 7 on the user PC (Web Browser), and so forth.

A top page (FIG. 6) for the management is a Web page displayed at first via the auction device 10 on the management-dedicated PC (Web Browser) having an access to the self-device. The top page for the management contains a plurality of items (which will hereinafter be termed link anchors to price evaluation pages) that are manipulated for displaying the price evaluation pages having a structure shown in FIG. 8 with respect to a commodity in a specified genre. A content of the operation of the auction device 10 about these price evaluation pages will be described later on, however, the auction device 10 according to the present embodiment is the device operated in such a form that the operator properly executes a process of setting and changing correction values about the respective commodities in a way that makes the use of the price evaluation pages with respect to the individual commodities.

The top page (FIG. 7) is the Web page displayed via the auction device 10 to the user PC (Web Browser) having the access to the self-device.

The top page contains an item (which will hereinafter be referred to as a link anchor to a member registration page) manipulated for displaying the member registration page, and an item (which will hereinafter be referred to as the link anchor to the member registration page) manipulated for displaying a log-in dialog box.

The member registration page displayed by manipulating the link anchor to the member registration page on the top page, is the Web page for a member registration procedure. The member registration page is a page to which a name, an E-mail address, a password, etc can be inputted as in the case of the generally used Web page for the member registration procedure. Then, the member information database 11 installed in the HDD 21 of the auction device 10 is, as apparent from FIG. 2, a database stored with information (record) consisting of various items of information inputted to this member registration page by a person making the member registration procedure, a member ID assigned to the person making the member registration procedure from the auction device 10, and so on.

The member top page (FIG. 7) is a Web page displayed by inputting the member ID and the password (these 2-tuple items are stored in the member information database 11) to the log-in dialog box displayed when manipulating the link anchor to the member top page on the top page.

The member top page contains an item (which will hereinafter be termed a link anchor to a commodity exhibition request page) manipulated for displaying the commodity exhibition request page, and a plurality of items (which will hereinafter be referred to as link anchors to commodity introduction pages) manipulated for displaying the commodity introduction pages about the commodities in specified genres. Further, the member top page contains an item (if this item is manipulated, the auction device 10 determines whether or not there is source data of a price check page about the operator and, if the source data of a price check page about the operator exists, sends back the source data; this item will hereinafter be termed a link anchor to the price check page) manipulated for displaying the price check page by a recipient of a price change request mail (an in-depth description thereof will be given later on).

Note that the price auction device 10, when providing the member-dedicated top page to a certain member (when the 2-tuple of the member ID and the password registered in the member information database 11 is inputted to the log-in dialog box), starts a session management process (which is a process of treating, thereafter, a variety of requests sent from the user PC of the member concerned as those given from the same user PC of the same member) for the member

The commodity introduction page displayed by manipulating the link anchor to each commodity introduction page on the member top page is, as schematically illustrated in FIG. 9, a Web page containing a commodity catalog area 51, a suggested sales price display box 52, a suggested purchase price box 53, a return button 54, a log-out button 55, a suggested purchase price transmission button 56, a previous button 57, a next button 58, etc.

The commodity catalog area 51 contained in this commodity introduction page is an area in which to display various items of information on the sales target commodity such as a name of the commodity and image information representing an external appearance of the commodity. The suggested sales price display box 52 is a box in which to display an item of suggested sales price (the details will be explained later on) set for the sales target commodity. The suggested purchase price box 53 is a box to which an item of suggested purchase price (bidding price) of the sales target commodity is inputted.

The previous button 57 and the next button 58 are buttons pressed for displaying the commodity introduction pages of a previous commodity and a next commodity belonging to the same genre on the display (in a widow of the Web Browser) of the user PS. The previous button 57 and the next button 58 are, however, buttons functioning only when the commodity introduction pages showing the previous commodity belonging to the same genre are displayed.

The return button 54 is a button pressed for displaying the member top page on the display. The log-out button 55 is a button pressed for terminating the session management process executed by the auction device 10 for a person who browses the commodity introduction pages. Further, the log-out button 55 is also a button pressed for displaying a so-called Thank-you page on the display.

The suggested purchase price transmission button 56 is a button that should be pressed after the member considering to purchase the sales target commodity introduced on the commodity introduction page will have inputted the suggested purchase price to the suggested purchase price input box 53.

When pressing the suggested purchase price transmission button 56, the user PC transmits the suggested purchase price inputted to the suggested purchase price input box 53, a commodity code of the sales target commodity and a biding request containing the member ID of the user performing the manipulations on the screen and the member ID of the commodity exhibitor of the sales target commodity, toward the auction device 10 via the communication line.

The auction device 10 receiving the bidding request from the user PC refers to a price registered in a recommended suggested sales price box in the suggested sales price database 14 about the commodity specified by the received data, and, if the suggested purchase price is lower than the recommended suggested sales price, validates the received bidding request. Moreover, if over the price registered in the recommended suggested sales price box, the auction device 10 invalidates the bidding request, and it follows that a dialog box displaying a message purporting that the inputted suggested purchase price is too high, is displayed on the user PC transmitting the bidding request. Note that the member employing the user PC receiving the message purporting that the inputted suggested purchase price is too high can recognize a necessity for re-inputting a suggested purchase price lower than the previously-inputted price by looking up the message in the case of bidding the commodity concerned.

Then, the suggested purchase price database 13 stored in the HDD 21 of the auction device 10 is, as apparent from FIG. 4, a database to which the information (a record) consisting of the suggested purchase price contained in the bidding request and the member ID of the member operating the user PC to transmit the bidding request is added as the suggested purchase information from the auction device 10 receiving the bidding request.

The commodity exhibition request page (see FIG. 7) displayed by manipulating the link anchor to the commodity exhibition request page on the member top page, is defined as a Web page containing a plurality of information input boxes to which to input commodity specifying information, commodity status information, remark information, sales period designating information and a designated suggested sales price, an image file name input box to which an image file name is inputted, a reference file name input box to which a reference file name is inputted, a transmission button, etc.

The commodity specifying information, which should be inputted to the commodity exhibition request page by the member (the commodity exhibition requester), is a group of information, known to the commodity exhibitor as the information available for specifying the commodity, such as a name and a model number of the commodity requested for the exhibition. Further, the commodity status information represents a status of the exhibition-requested commodity, such as being flawless and unopened. An auction ending day is defined as information for designating an ending day of a period for accepting the bids of the exhibition requested commodity (a starting day of this period will be explained later on). The remark information is information exerting influence on the price of the exhibition requested commodity other than the commodity specifying information and the commodity status information. The image file name is a name of an image file (prepared by the member) depicting the external appearance of the exhibition requested commodity. The reference file name is a name of, e.g., a written appraisal file for verifying a value of the exhibition requested commodity. The designated suggested sales price is a price considered desirable, to the member as the commodity exhibition requester, as an equivalent value of the exhibition requested commodity.

The transmission button provided on the exhibition request page is a button pressed for transmitting the information inputted to the variety of information input boxes provided on the commodity exhibition request page and the commodity exhibition request containing the files specified by the file names inputted to the respective file name input boxes, toward the auction device 10 via the communication line.

Then, the auction device 10 is configured as the device executing, when receiving the commodity exhibition request transmitted by pressing the transmission button provided on the commodity exhibition request page, a commodity exhibition request responding process of which a procedure is illustrated in FIG. 10.

Described before explaining a content of the commodity exhibition request responding process are a structure of the commodity information database 12 (FIG. 3) and a structure of a sales target commodity information database 14 (FIG. 5) that are used when executing the commodity exhibition request responding process.

As shown in FIG. 3, the commodity information database 12 is stored with commodity information records of a multiplicity of commodities, each record containing commodity specifying information, a genre code, a commodity code and a reference price.

The commodity specifying information set in each of the commodity information records of the commodity information database 12 is a set of data usable for specifying the commodity, such as information consisting of a name of the commodity, a name of a manufacturer of the commodity, a model number, etc. The commodity code is defined as information used by the auction device 10 as identifying information of a corresponding commodity (specified by the commodity specifying information or the commodity code in the same commodity information record). The genre code is defined as information employed by the auction device 10 as information specifying a genre to which the corresponding commodity such as a toy and a coin belongs, and the reference price, which is a so-called market price, is defined as information used by the auction device 10 as a general sales price if the corresponding commodity has a normal quality.

In short, the commodity information database 12 is prepared within the auction device 10 in order to enable the commodity code, the genre code and the reference price to be searched from the items of information such as the name of the commodity inputted to the commodity exhibition request page by the exhibition requester.

The sales target commodity information database 14 (FIG. 5) is stored with various items of information on the commodity of which the exhibition request was accepted. The sales target commodity information database 14 has, as illustrated, a structure capable of storing sales target commodity information records each containing a genre code, a commodity code, a seller member ID, commodity specifying information, commodity status information, sales period designating information, remark information, an image file name, a reference file name, a designated suggested sales price, a reference price, a commodity status correction factor, a recommended suggested sales price, an entered suggested purchase price and a status.

Then, the commodity exhibition request responding process (FIG. 10) executed by the auction device 10 has the following content that is carried out by use of these databases.

Namely, the auction device 10 starting the commodity exhibition request responding process executes, at first, a process of reading the genre code, the commodity code and the reference price about the commodity requested for the exhibition (which will hereinafter be referred to as an exhibition request target commodity) from the commodity information database 12 (FIG. 3) (step S101). To be more specific, in this step S101, the auction device 10 executes the process of reading the genre code, the commodity code and the reference price, which are associated with the commodity specifying information of which main items are coincident with those of the commodity specifying information contained in the received commodity exhibition request, from the commodity information database 12.

Subsequently, the auction device 10 executes a process of adding, to the sales target commodity information database 14 (FIG. 5), the sales target commodity information record containing the genre code, the commodity code and the reference price read from the commodity information database 12, the various items of information included in the received commodity exhibition request and the member ID of the member who has got the user PC to transmit the commodity exhibition request, “0” as a correction factor and “not-yet-evaluated” as a status (step S102). The auction device 10 also executes a process of displaying a commodity exhibition request acceptance completion notifying page on the sender user PC of the commodity exhibition request (step S103). Note that the commodity exhibition request acceptance completion notifying page is a Web page for notifying the exhibition requester that the exhibition request was accepted and that an e-mail is sent when starting disclosing the commodity introduction pages or when required to review the suggested sales price.

Then, the auction device 10 terminating the process in step S103 executes a process of generating source data for a price evaluation page that is displayed on the management-dedicated PC employed by the operator with respect to the exhibition request target commodity (step S104).

Herein, the price evaluation page represents a Web page containing, as illustrated in FIG. 8, a commodity catalog dedicated area 71, a status display box 72, a designated suggested sales price display box 73, a reference price display box 74, a commodity status correction factor input box 75, a recommended suggested sales price display box 77, a setting button 78, an end button 79, a previous button 80, a next button 81, etc.

An item of commodity status correction factor can be inputted (a numerical value displayed inside is changed) to the commodity status correction factor input box 75 provided on the price evaluation page. An item of recommended suggested sales price calculated in the following formula (1) from the commodity status correction factor inputted to the commodity status correction factor input box 75 and from the designated suggested sales price displayed in the designated suggested sales price display box 73, is displayed in the recommended suggested sales price display box 77.
Recommended Suggested Sales Price=Reference Price×(100+Commodity Status Correction Factor)×Specified Value/100 (1)

Note that the specified value in the formula (1) is a predetermined value (which is 1.1 in the present embodiment) and is a value that can be separately properly set by the operator.

The setting button 78 is a button pressed for transmitting an evaluation result registration request containing the commodity status correction factor and the recommended suggested sales price at that point of time, the commodity code of the commodity of which the various information is displayed on the price evaluation page and the member ID of the member exhibiting the commodity (which will hereinafter be also called a seller member ID), toward the auction device 10 via the communication line.

The previous button 80 and the next button 81 are buttons pressed for displaying, if there exist the price evaluation pages of the previous commodity and the next commodity belonging to the same genre, these price evaluation pages on the display (in the window of the Web Browser) of the management-dedicated PC. The end button 79 is a button pressed for redisplaying the top page for the management on the display.

Then, the process executed in step S104 (FIG. 10) is a process of generating the source data, from which the price evaluation pages having the contents corresponding to the various items of information added to within the sales target commodity information database 14 in the process of step S102 can be displayed on the Web Browser, by processing the template data for the price evaluation pages prepared on the HDD 21. Further, the process of step S104 involves executing a process (of linking the price evaluation page with the source data generated to the next button 81 provided on the existing price evaluation page) of changing the content of the already-generated source data for the specified price evaluation page.

Incidentally, though the in-depth description is omitted, the auction device 10 discards the generated source data for the price evaluation pages at 24:00 on the auction ending day. Note that it can be determined corresponding to an operation status when the source data for the price evaluation pages are to be discarded.

The auction device 10 is configured to start, when receiving the evaluation result registration request, an evaluation result registration request responding process in a procedure shown in FIG. 11.

Namely, the auction device 10 receiving the evaluation result registration request, to begin with, searches the sales target commodity information database 14 for the record of the exhibition request target commodity specified by the commodity code and the seller member ID contained in the received evaluation result registration request, and rewrites the commodity status correction factor and the recommended suggested sales price, which are contained in the record of the exhibition request target commodity, into those contained in the received evaluation result registration request (step S201). Subsequently, the auction device 10 determines a relationship in magnitude (price value) between the recommended suggested sales price and the designated suggested sales price of the exhibition request target commodity (step S202).

If the recommended suggested sales price is over the designated suggested sales price (step S202: YES), the auction device 10 executes a process of changing the entered suggested sales price and the status in the record of the exhibition request target commodity into the same price as the designated suggested sales price and “evaluation completed” (step S203), and a process of processing the source data for the price evaluation page about the exhibition request target commodity into the source data from which to display the price evaluation page where each item of post-changing information is shown as an initial value or unchangeable information (step S204).

Then, the auction device 10, after carrying out the process of generating the source data for the commodity introduction page of the exhibition request target commodity (step S205) and a process of transmitting a disclosure start notifying mail for notifying that the disclosure of the commodity introduction page is started to the exhibition requester of the exhibition request target commodity (step S206), terminates this evaluation result registration request responding process.

Whereas if the recommended suggested sales price is lower than the designated suggested sales price (step S202; NO), the auction device 10 executes a process of changing the status in the record of the exhibition request target commodity to “under check” (step S207), and a process of processing the source data for the price evaluation page about the exhibition request target commodity into the source data from which to display the price evaluation page where each item of post-changing information is shown as the initial value or the unchangeable information (step S208).

Thereafter, the auction device 10 executes a process of generating source data for a price check page about the exhibition request target commodity (step S209).

The price check page, of which the source data are generated in the process of step S209, is a Web page containing, as shown in FIG. 12, a commodity catalog area 61 that displays various items of information concerning a focused commodity such as a name of the commodity and image information illustrating an external appearance of the commodity, a designated suggested sales price display box 62 that displays a designated suggested sales price of the focused commodity, a recommended suggested sales price display box 63 that displays a recommended suggested sales price, and so on. The price displayed in the designated suggested sales price display box 62 is set in a status updatable by the member as the exhibition requester, while the price displayed in the recommended suggested sales price display box 63 is set in an unupdatable status.

A return button 64 and a log-out button 65 provided on the price check page have the same functions as those of the return button 54 and the log-out button 55 on the commodity evaluation page. A previous button and a next button 69 are buttons pressed for displaying, if there exist the price check pages of the previous commodity and the next commodity belonging to the same genre, these price check pages on the display (in the window of the Web Browser) of the user PC.

A price consent button 66 is a button pressed by the member if the suggested sales price may be changed to the recommended suggested sales price. When pressing the price consent button 66, the user PC displaying the price check page transmits, to the auction device 10, a consent response containing the commodity ID of the commodity of which the various items of information are displayed on the price check page and the information showing that the price consent button 66 is pressed. Note that the exhibition requester can change the price previously displayed in the designated suggested sales price display box 62 by use of the price check page, wherein the recommended suggested sales price is set as an upper limit. If the data in the designated suggested sales price display box 62 is updated, it follows that the user PC transmits, when pressing the price consent button 66, the data of the post-updating designated suggested sales price together with the consent response to the auction device 10. Further, when a cancel button 67 is pressed, the user PC displaying the price check page transmits a request for cancelling the commodity of which the various items of information are displayed on the price check page to the auction device 10.

In short, in step S209, the auction device 10 executes a process that enables the user PC of the exhibition requester to display the price check page through which the exhibition requester designating the suggested sales price exceeding the recommended suggested sales price determined on the side of the auction device 10 with respect to the exhibition target commodity, is queried about whether the suggested sales price may be changed to the recommended suggested sales price or whether the suggested sales price may be changed lower than the recommended suggested sales price or whether the exhibition of the commodity is cancelled.

The auction device 10 executing this process in step S209 carries out a process of transmitting a price change request mail, for notifying that the content of the price check page should be checked, to the exhibition requester (step S210), and thereafter terminates the evaluation result registration request responding process.

Then, the auction device 10 starts, if the exhibition requester receiving the price change request mail displays the price check page on the user PC of the requester himself or herself and presses the price consent button 66 or the cancelling button 67, i.e., in the case of receiving the consent response or the cancelling request from the user PC on which the price check page is displayed, a consent/cancelling request responding process of which a content is illustrated in FIG. 13.

Namely, the auction device 10, at first, determines whether or not the received response is a consent response connoting that the change in price is consented (step S301). Then, the auction device 10 executes, if the received response does not connote the consent of the change in price but connotes the cancelling request (step S301; NO), a process of erasing the record of the exhibition request target commodity from each of the databases (step S306) and a process of transmitting source data for a completion-of-cancellation notifying page to the user PC of the request sender (step S307), and thereafter terminates the consent/cancellation request responding process.

Whereas if the received response is the consent response connoting that the change in price is consented (step S301; YES), the auction device 10 executes a process of changing the entered suggested sales price of the exhibition request target commodity and the status in the sales target commodity information database 14 to the same price as the recommended suggested sales price and “disclosure completed” (step S302) and a process of processing the source data for the price evaluation page about the exhibition request target commodity into source data from which to display the price evaluation page where each item of post-changing information is shown as an initial value or unchangeable information (step S303). Note that when receiving the post-updating designated suggested sales price together with the consent response, it is rechecked whether the designated suggested sales price is equal to or lower than the recommended suggested sales price, and, if equal to or lower than the recommended suggested sales price, the price in the designated suggested sales price box within the sales target commodity information database 14 is changed to the post-updating price, while the entered suggested sales price of the exhibition request target commodity and the status are changed to the same price as the post-updating designated suggested sales price and “disclosure completed”. Incidentally, as a result of checking, if the designated suggested sales price exceeds the recommended suggested sales price, the processes continued from “NO” in step S202 are again executed.

Thereafter, the auction device 10, after executing a process of generating the source data for the commodity introduction page of the exhibition request target commodity (step S304) and a process of transmitting, to the requester user PC, source data for a disclosure start notifying page for notifying that the disclosure of the commodity introduction page is started (step S305), terminates the evaluation result registration request responding process.

As discussed above, the auction device 10 according to the present embodiment, if the upper limit value of the bidding price designated by the commodity exhibition requester is excessively high (see FIG. 11), avoids the commodity requested for the exhibition by the exhibition requester from becoming directly the auction target commodity. Further, the auction device 10 handles the auction of the commodity in the form of restricting the upper limit value of the bidding price. Hence, the use of the auction device 10 enables realization of an environment where the variety of commodities are put on sale at the auction in a form that prevents the variety of commodities from being sold at excessively high prices.

What is claimed is:

1. An auction device that performs an auction via a network, comprising:
reference price storage means stored previously with a reference price corresponding to a type and a status of a commodity with respect to each of a multiplicity of commodities;
acquiring means acquiring commodity information representing a type and a status of an exhibition request target commodity as an auction target commodity, and also a designated suggested sales price; and
suggested sales price adjusting means calculating, with respect to the exhibition request target commodity, a recommended suggested sales price by use of the reference price stored in said reference price storage means and the commodity information, and outputting, if the calculated recommended suggested sales price is lower than the designated suggested sales price acquired by said acquiring means, an instruction of changing the designated suggested sales price.

2. An auction device according to claim 1, wherein said suggested sale price adjusting means prompts an operator to input a correction coefficient used for the exhibition request target commodity, and calculates the recommended suggested sales price by an arithmetic process using the inputted correction coefficient and a reference price of the commodity that is stored in said reference price storage means.

3. An auction device according to claim 1, further comprising:
sales target commodity registering means registering, if the designated suggested sales price is equal to or lower than the recommended suggested sales price, the exhibition request target commodity as an auction target commodity;
commodity information presenting means outputting information on the exhibition request target commodity registered by said sales target commodity registering means in a biddable status; and
bid accepting means accepting a bid of the outputted exhibition request target commodity if the inputted bidding price is equal to or lower than the recommended suggested sales price calculated about the exhibition request target commodity.

4. An auction program for making a computer function as a device comprising:
reference price storage means stored previously with a reference price corresponding to a type and a status of a commodity with respect to each of a multiplicity of commodities;
acquiring means acquiring commodity information representing a type and a status of an exhibition request target commodity as an auction target commodity, and also a designated suggested sales price; and
suggested sales price adjusting means calculating, with respect to the exhibition request target commodity, a recommended suggested sales price by use of the reference price stored in said reference price storage means and the commodity information, and outputting, if the calculated recommended suggested sales price is lower than the designated suggested sales price acquired by said acquiring means, an instruction of changing the designated suggested sales price.
